(19) United States
(12) Patent Application Publication
(10) Pub. No.: US 2013/0139959 A1
(43) Pub. Date: Jun. 6, 2013

(54) PRODUCTION METHOD AND PRODUCTION LINE FOR PRE-PRINTED SURFACE PAPER CORRUGATED BOARDS

(71) Applicant: Jiashui WANG, Qingdao (CN)

(72) Inventor: Jiashui WANG, Qingdao (CN)

(73) Assignee: QINGDAO MEIGUANG MACHINERY CO., LTD., Qingdao (CN)

(21) Appl. No.: 13/644,804

(22) Filed: Oct. 4, 2012

Related U.S. Application Data
(63) Continuation of application No. PCT/CN2011/070985, filed on Feb. 15, 2011.

(30) Foreign Application Priority Data
Nov. 30, 2010 (CN) 201010586346.6

(51) Int. Cl. B31F 1/00

(52) U.S. Cl. CPC B31F 1/00
USPC 156/210; 156/470

(57) ABSTRACT

The disclosure provides a production method and production line for pre-printed surface paper corrugated boards, and the production method and production line provided by the invention can be used for solving the problem that the existing corrugated board production line and process cannot adapt to the production of pre-printed colorful corrugated boards. In the disclosure, because the bonding mode that surface paper is arranged on a single-face corrugated board is adopted, the direct contact between color-printed paper and a high temperature heating plate of a drying part can be avoided, thereby effectively preventing the damages on the materials, patterns, gloss oil and plastic films of the color-printing paper. The disclosed corrugated board production method and corrugated board production line can effectively adapt to the application requirements of pre-printed colorful paper on the premise of not increasing the cost.

### RELATED APPLICATIONS

This application claims priority as a continuation application under 35 U.S.C. §120 to PCT/CN2011/070985, which was filed as an International Application on Feb. 15, 2011 designating the U.S., and which claims priority to Chinese Application 201010586346.6 filed in China on Nov. 30, 2010. The entire contents of these applications are hereby incorporated by reference in their entireties.

### FIELD OF THE DISCLOSURE

The present disclosure belongs to the corrugated board manufacturing field, and relates to a novel corrugated paperboard manufacturing mode which includes conveying a single-face corrugated board, gluing the single-face corrugated paperboard, adhering to face paper, such as pre-printed paper, and drying the double-face corrugated paperboard. In particular, the disclosure relates to a solution which can ensure the single-face corrugated board strongly adheres to the pre-printed paper and prevents the pre-printed paper from being damaged during the manufacturing process.

### BACKGROUND OF THE DISCLOSURE

Common manufacturing processes of the pre-printed paper corrugated board is shown in FIG. 1: in the single face corrugated machine, rolled paper 1-2 after being preheated is pressed into corrugated shape by corrugation rolls, and then bonded with the rolled paper 1-2 via gluing by a gluing device 1-9 to form a single face corrugated board which is accumulated on transportion paper wheels 1-3 in a wavelike form and meanwhile slowly conveyed forward. The single face corrugated board 1-6 output by the transportion paper wheels 1-3 passes through a preset device 1-10 and then is glued by a gluing device 1-11 and converged with a face paper 2-1 to form a double face corrugated board which will enter into a drying device 3. The double face corrugated board drove by a conveyor transports forward, of which the face paper is in direct contact with the heating plates 3-1. One object of heating and drying is to enable the glue in the corrugated board to be cured and glued, in particularly to evaporate the water in the glue, thus forming a smooth and straight corrugated board; the double face corrugated board output by the drying device 3 is cut into predetermined size pieces of double face corrugated board after passing through a slitter 4 and an NC cutter 5, then forming a paper pile 7 by a stacker 6.

In above manufacturing process, usually rolled paper is pressed into corrugated shape first, then glued to backing paper to forming a single face corrugated board, then glued to face paper to forming a double face corrugated board after gluing on the corrugation; and then the corrugated board, after being dried, is cut into predetermined size pieces of double face corrugated board, lastly forming a paper pile by a stacker. Therein, the relative position of the single face corrugated board and the face paper is that the face paper is arranged under the corrugated board. Thus, during drying the double face corrugated board, the face paper is always under the corrugated board, thus the face paper is in direct contact with a high-temperature hot plate of a drying part, which causes defects such as discoloration and scratches on the face paper. Such defects on the face paper are not obvious when yellow board or common white board without printed patterns are adopted. However, when white board with printed patterns or coated white board are adopted, said defects become conspicuous; not merely the board color is changed, but also the printed patterns tone is distorted and scratches are caused on the color surface. If the color surface is coated with gloss oil, the polishing will be damaged, and if with a plastic film, the plastic film will melt and deform. Therefore, the gluing manner that the face paper is arranged under the corrugated board can not adapt to manufacturing the pre-printed color surface corrugated boards.

### SUMMARY

The present disclosure provides a production method and production line for pre-printed corrugated boards, which can solve the problem that existing production method and production line can not adapt to manufacturing the pre-printed color surface corrugated boards.

In order to solve above problem, the solution according to present disclosure is a production method for pre-printed paper corrugated boards, wherein the production line of said production method includes a corrugated machine, multiple guiding rolls, at least one face paper guiding roller, a roll stand, rolled face paper, a gluing device and pressure rolls; said multiple guiding rolls constitute the conveying device of the corrugated boards, wherein the corrugated boards which are output by the corrugated machine, conveyed by the conveying device and glued by the gluing device in a single-side gluing manner are converged with a pre-printed paper output by the face paper guiding rolls at the pressure rolls; said pre-printed face paper is arranged on the corrugated board; then they enter into pressure rolls and glued together to form a pre-printed corrugated board.

Further, when said pre-printed corrugated board output by the pressure rolls enters into the drying device, the heating plates of the drying device are under the pre-printed corrugated board.

Further, said pre-printed corrugated board output by pressure rolls enters into the cutting device, of which the blades cut said pre-printed corrugated board into predetermined size pieces.

Further again, said corrugated board after being dried by the heating rolls is adhered to pre-printed face paper.

Further, the corrugated board is a double layer single-faced corrugated board, wherein the upper surface of the lower layer single-faced corrugated board and the upper surface of the upper layer single-faced corrugated board are glued by the gluing device respectively; the upper and lower single-faced corrugated boards and the pre-printed face paper are converged at the pressure rolls; said pre-printed face paper is arranged on the upper layer single-faced corrugated board; then upper and lower single-face corrugated boards and upper layer single-face corrugated board and the pre-printed face paper are glued together by the pressure rolls to form a double layer pre-printed corrugated board.

Alternatively, said corrugated board is single face; said corrugated machine is a single facer; said gluing device adopts ripe glue, said ripe glue is corn starch glue or white latex.

A production line for pre-printed corrugated boards includes a corrugated machine, multiple guiding rolls, at least one face paper guiding roller, a roll stand, rolled face paper, a gluing device and a pressure device; said multiple guiding rolls constitute the conveying device of the corrugated boards; said conveying device comprises a lower conveying device, which is arranged below the roll stand.

Further, said corrugated machine is a single facer; said gluing device consists of two tangent rolls; the area above the tangent line is storage space for glue.

Further, said pressure device is a pair of up and down arranged pressure rolls.

Further, said lower conveying device is arranged in the underground passage below the roll stand.

In order to overcome the defects caused by adopting existing corrugated board production line to manufacture face paper with pre-printed patterns, the present disclosure provides a novel corrugated paperboard manufacturing mode which includes conveying the single-face corrugated board, gluing the single-faced corrugated paperboard, adhering to face paper, drying the double-faced corrugated paperboard; and said manufacturing mode adopts a gluing manner that the face paper is arranged on the corrugated board, which enables avoiding the color-printed paper to be in direct contact with a high-temperature hot plate of a drying part so as to effectively prevent textures, patterns, gloss oil and a plastic film of the color-printed paper from being damaged. This novel production line enables effectively producing the pre-printed paper corrugated board by using pre-printed colorized paper with low manufacturing cost.

The present disclosure has the following advantages and positive results:

The present disclosure adopts a gluing manner that the face paper is arranged on the single-faced corrugated board, which enables avoiding a color face paper to be in direct contact with a high-temperature hot plate of a drying part so as to effectively prevent textures, patterns, gloss oil and a plastic film of the color-printed paper from being damaged.

The present disclosure adopts pipe glue such as corn starch glue or white latex to make the single faced corrugated board adhere to the face paper, which avoids high temperature gelatinization so as to effectively shorten adhesive time; if drying temperature is low, the adhesive effect can be even ensured without drying process, thereby further preventing the color face paper from being damaged by high temperature.

The present disclosure adopts pipe glue such as corn starch glue or white latex to make the single faced corrugated board adhere to the face paper, which ensures the adhesive effect of the face paper and single faced corrugated board without preheating; therefore saving the cost for preheating. If the invention adopts raw glue, the face paper and single face corrugated board are preheated before being adhered together; since the color face paper is on the top, it will not be in direct contact with preheat roll, thereby preventing patterns, gloss oil from being damaged.

### BRIEF DESCRIPTION OF THE DRAWINGS

FIG. 1 is a view of common manufacturing process of pre-printed paper corrugated boards
1 [symbol] a single face corrugated machine; 1-1 [symbol] a roll stand; 1-2 [symbol] rolled paper 1-3; transportion paper wheels 1-4 [symbol] guiding rolls; 1-5 [symbol] a corrugators roll; 1-6 [symbol] a single face corrugated board; 1-7 [symbol] pressure rolls; 1-8 [symbol] a preheating roll; 1-9 [symbol] a gluing device; 1-10 [symbol] a preset device for a single face corrugated machine; 1-11 [symbol] a gluing device; 2-1 [symbol] face paper; 2-2 [symbol] a guiding roll for face paper; 2-3 [symbol] a preset device for face paper; 2-4 [symbol] a roll stand for face paper; 3 [symbol] a drying device; 3-1 [symbol] heating plates; 3-2 [symbol] a conveyor belt; 4 [symbol] a slitter; 5 [symbol] an NC cutter; 6 [symbol] a stacker; 7 [symbol] a corrugated paper pile.

FIG. 2 is a schematic drawing of the production method and production line for pre-printed corrugated boards according to a first embodiment of the invention;

FIG. 3 is a schematic drawing of the production method and production line for pre-printed corrugated boards according to a second embodiment of the invention;

FIG. 4 is a schematic drawing of the production method and production line for pre-printed corrugated boards according to a third embodiment of the invention;

FIG. 5 is a schematic drawing of the production method and production line for pre-printed corrugated boards according to a fourth embodiment of the invention;
1 [symbol] a single face corrugated machine; 2 [symbol] a single face corrugated board; 3 [symbol] a guiding roll for corrugated boards ; 4 [symbol] a roll stand; 5 [symbol] rolled face paper; 6 [symbol] preprinted face paper; 7 [symbol] a gluing device; 8 [symbol] pressure rolls; 9 [symbol] a double face corrugated board; 10 [symbol] heating plates; 11 [symbol] a cutter; 12 [symbol] a cutter blade; 13 [symbol] heating rolls; 14 [symbol] a double-layer corrugated board; 15 [symbol] a drying device; 16 [symbol] a guiding roll for face paper; 17 [symbol] a lower conveying device; 18 [symbol] a underground passage.

### PREFERRED EMBODIMENTS

### Embodiment 1

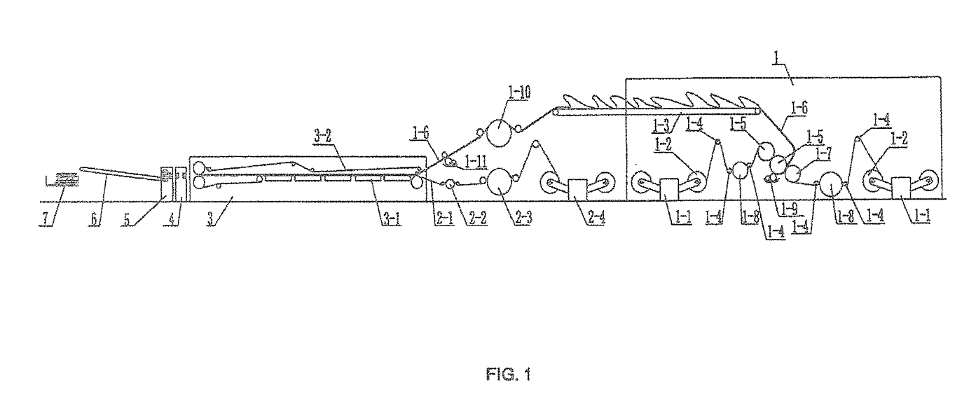

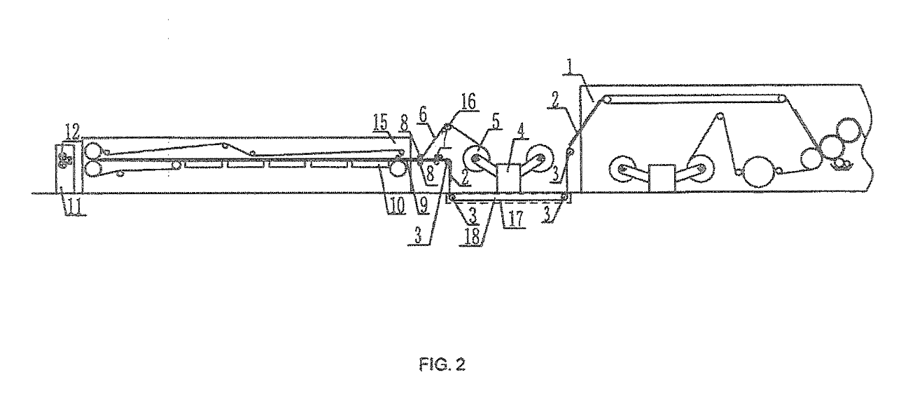

Referring to FIG. 2, a production line for pre-printed corrugated boards includes a single faced corrugated machine 1, four guiding rolls 3, one face paper guiding roll 16, a roll stand 4, rolled face paper 5, a gluing device 7, and a pressure device 8. Said four guiding rolls constitute the conveying device of the corrugated boards to convey the single face corrugated board 2 from the single faced corrugated machine 1 to the pressure device 8. Said conveying device comprises a lower conveying device 17, which is arranged below the roll stand 4.

An underground passage 18 is dug below the roll stand 4, and the lower conveying device 17 is arranged in the underground passage 18, and the single faced corrugated board 2 passes though said passage 18. The length which the lower conveying device 17 and the underground passage 18 are across is longer than the distance between outer diameters of two rolls of face paper 5 supported by the roll stand 4.

When working, the single faced corrugated board 2 produced by the single faced corrugated machine 1 passes by the guiding rolls 3 and gets out of the underground passage 18 below the roll stand 4 and then passes by the gluing device 7 by which the corrugated board is glued. Meanwhile, rolled face paper 5 supported by the roll stand 4 is unreeling continuous pre-printed face paper 6 which is adhered to the glued single faced corrugated board 2 between the pressure rolls 8; the pre-printed face paper 6 is on the single faced corrugated board 2, thus forming the corrugated boards with pre-printed face paper, that is the double faced corrugated board 9 which enters into the drying device 15 and is dried. Multiple heating plates 10 of the drying device 15 are located below the double face corrugated board 9. It is obvious from above description that, the pre-printed face paper 6 on the double faced corrugated board 9 is not in direct contact with the heating plates so as to effectively prevent textures, patterns, gloss oil and a plastic film of the pre-printed paper 6 from being damaged.

### Embodiment 2

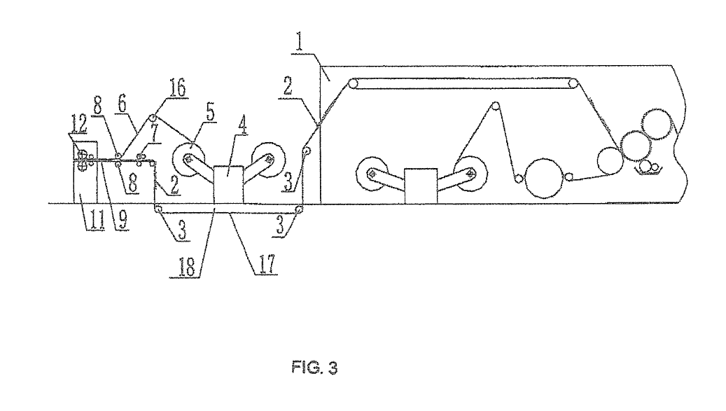

As a modification of above solution, shown in FIG. 3, the double faced corrugated board 9 directly enters into a cutter device 11 without being dried by the drying device 15; then it is cut into predetermined size pieces of double face corrugated board, thereby avoiding high temperature to influence the pre-printed face paper of the corrugated board.

### Embodiment 3

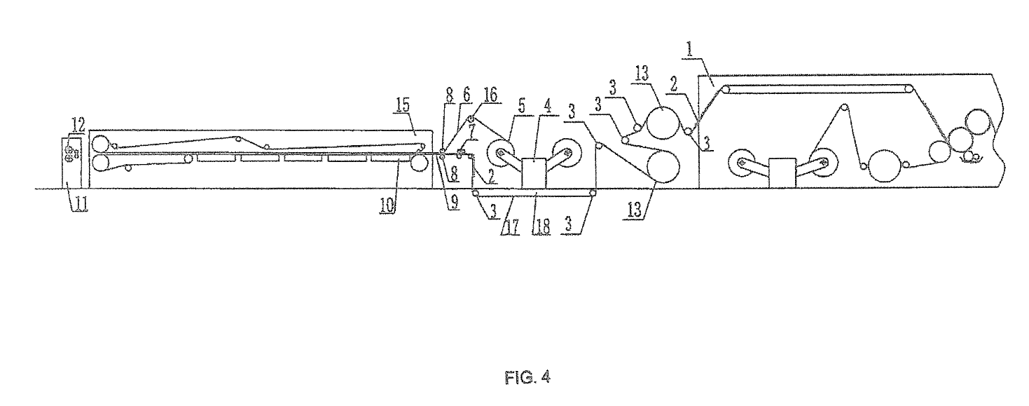

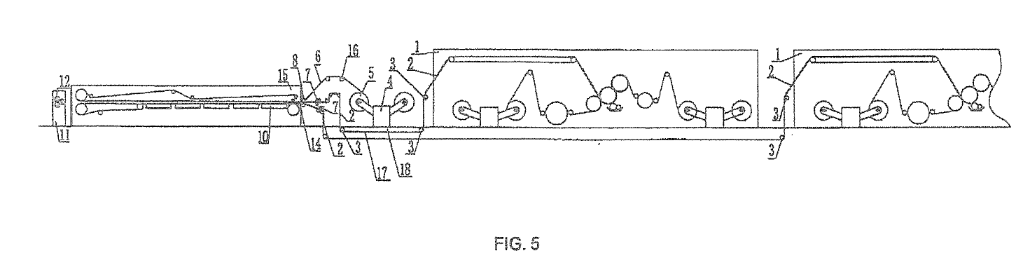

As an another modification of embodiment 1, referring to FIG. 4, the single faced corrugated board 2 passes by two heating rolls 13, then enters into the lower transportion device 17 after being dried, and then adheres to the pre-printed face paper 6. The drying process of the single face corrugated board 2 can improve adhesive effect of the double face corrugated board 9.

### Embodiment 4

As an another modification of embodiment 1, as shown in FIG. 5, a double layer single-faced corrugated board 2 and a pre-printed face paper 6 are glued together, thus forming a double layer corrugated board 14.

Said gluing device 7 consists of two tangent rolls which both reversely rotate inward; the area above the tangent line is storage space for glue, and the glue spread may be modulated by adjusting the gap between two rolls. When the single corrugated board passes under the gluing device 7, the lower edges of the rolls are in contact with the corrugation top of the single face corrugated board 2, thus defined amount of glue is coated on the single face corrugated board 2.

Said pressure rolls 8 consist of a pair of up and down arranged pressure rolls which reversely rotate. The gap between the two rolls can be regulated according to the corrugated board thickness. When the single faced corrugated board 2 and the pre-printed face paper 6 pass though the upper and lower rolls, they are glued together via pressing by the upper and lower pressure rolls.

The gluing device 7 adopts pipe glue such as corn starch glue or white latex, which avoids high temperature gelatinization so as to effectively shorten adhesive time; if drying temperature is low, the adhesive effect can be even ensured, thereby further preventing the color face paper from being damaged by high temperature.

It is to be understood that above detail is not to limit the present invention, and the invention is not limited to the disclosed embodiments, but, on the contrary, is intended to cover variations, modifications, addition or equivalent arrangements that are within the spirit and scope of the appended claims.

1. A production method for pre-printed paper corrugated boards, wherein the production line of said production method includes a corrugated machine, multiple guiding rolls, at least one face paper guiding roller, a roll stand, rolled face paper, a gluing device and pressure rolls; said multiple guiding rolls comprise a conveying device of the corrugated boards, the method comprising:
the corrugated boards which are output by the corrugated machine, conveyed by the conveying device and glued by the gluing device in a single-side gluing manner are converged with a pre-printed paper output by the face paper guiding rolls at the pressure rolls;
arranging said pre-printed face paper on the corrugated board; and
the pre-printed face paper and the corrugated board enter into the pressure rolls and are glued together to form a pre-printed corrugated board.

2. The production method for pre-printed paper corrugated boards according to claim 1, wherein when said pre-printed corrugated board output by the pressure rolls enters into the drying device, the heating plates of the drying device are under the pre-printed corrugated board.

3. The production method for pre-printed paper corrugated boards according to claim 1, wherein said pre-printed corrugated board output by pressure rolls enters into a cutting device, of which the blades cut said pre-printed corrugated board into predetermined size pieces.

4. The production method for pre-printed paper corrugated boards according to claim 1, wherein said corrugated board after being dried by the heating rolls is adhered to pre-printed face paper.

5. The production method for pre-printed paper corrugated boards according to claim 1, wherein:
the corrugated board is a double layer single-faced corrugated board, wherein the upper surface of the lower layer single-faced corrugated board and the upper surface of the upper layer single-faced corrugated board are glued by the gluing device respectively;
the upper and lower single-faced corrugated boards and the pre-printed face paper are converged at the pressure rolls;
said pre-printed face paper is arranged on the upper layer single-faced corrugated board;
then upper and lower single-faced corrugated boards and upper layer single-faced corrugated board and the pre-printed face paper are glued together by the pressure rolls to form a double layer pre-printed corrugated board.

6. The production method for pre-printed paper corrugated boards according to claim 1, wherein said corrugated board is single faced; said corrugated machine is a single facer; said gluing device adopts ripe glue, said ripe glue is corn starch glue or white latex.

7. A production line for pre-printed corrugated boards comprising:
a corrugated machine,
multiple guiding rolls,
at least one face paper guiding roll,
a roll stand,
rolled face paper,
a gluing device, and
a pressure device;
wherein said multiple guiding rolls comprise a conveying device of the corrugated boards; and
wherein said conveying device comprises a lower conveying device, which is arranged below the roll stand.

8. The production line for pre-printed corrugated boards according to claim 7, wherein said corrugated machine is a single facer; said gluing device consists of two tangent rolls; the area above the tangent line is storage space for glue.

9. The production line for pre-printed corrugated boards according to claim 8, wherein said pressure device is a pair of up and down arranged pressure rolls.

10. The production line for pre-printed corrugated boards according to claim 7, wherein said lower conveying device is arranged in the underground passage below the roll stand.

11. The production method for pre-printed paper corrugated boards according to claim 2, wherein said corrugated board is single faced; said corrugated machine is a single facer; said gluing device adopts ripe glue, said ripe glue is corn starch glue or white latex.

12. The production method for pre-printed paper corrugated boards according to claim 3, wherein said corrugated board is single faced; said corrugated machine is a single facer; said gluing device adopts ripe glue, said ripe glue is corn starch glue or white latex.

13. The production method for pre-printed paper corrugated boards according to claim 4, wherein said corrugated board is single faced; said corrugated machine is a single facer; said gluing device adopts ripe glue, said ripe glue is corn starch glue or white latex.

14. The production line for pre-printed corrugated boards according to claim 8, wherein said lower conveying device is arranged in the underground passage below the roll stand.

15. The production line for pre-printed corrugated boards according to claim 9, wherein said lower conveying device is arranged in the underground passage below the roll stand.
